(19) United States
(12) Patent Application Publication
(10) Pub. No.: US 2024/0345199 A1
(43) Pub. Date: Oct. 17, 2024

(54) ROBOTIC VEHICLE SENSOR SYSTEM TO TRACK PERSONNEL

(71) Applicant: Battelle Memorial Institute, Columbus, OH (US)

(72) Inventors: Garrett DOWD, Columbus, OH (US); Gregory COLVIN, Columbus, OH (US)

(21) Appl. No.: 18/634,202

(22) Filed: Apr. 12, 2024

Related U.S. Application Data
(60) Provisional application No. 63/459,553, filed on Apr. 14, 2023.
(60) Provisional application No. 63/594,331, filed on Oct. 30, 2023.
(60) Provisional application No. 63/459,561, filed on Apr. 14, 2023.

(51) Int. Cl. G01S 5/02; G01S 5/00; G01S 11/02; G01S 11/04

(52) U.S. Cl. CPC G01S 5/0249; G01S 5/0072; G01S 5/0284; G01S 11/026; G01S 11/04; G01S 2205/09

(57) ABSTRACT

A system to track personnel includes an antenna array associated with a first node to communicate with a second node; and processor circuitry. The processor circuitry to: determine a plurality of positions of the second node; determine a distance between the first node and the second node; determine a bearing between the first node and at least one of the positions; and determine a direction for the first node based on the bearing.

### CROSS-REFERENCE TO RELATED APPLICATIONS

The present application claims the benefit of the filing date of U.S. Provisional Application Ser. No. 63/459,553, filed Apr. 14, 2023, U.S. Provisional Application Ser. No. 63/594,331, filed Oct. 30, 2023, and U.S. Provisional Application Ser. No. 63/459,561, filed Apr. 14, 2023, the entire teachings of which applications are hereby incorporated herein by reference.

### TECHNICAL FIELD

The present disclosure relates generally to a sensor system to track personnel.

### BACKGROUND

Robotic systems intended for use in close proximity of dismount personnel currently require a dedicated operator with Line of Sight (LoS) of the platform for control. This presents many issues, the greatest of which is the reduction or removal of an existing role within a squad due to the cognitive burden of robot operation.

### BRIEF DESCRIPTION OF THE DRAWINGS

Reference should be made to the following detailed description which should be read in conjunction with the following figures, wherein like numerals represent like parts.

FIG. 1 is an example functional block diagram of a sensor system to track personnel, consistent with the present disclosure.

FIG. 2 is a chart showing the reliability of the system of FIG. 1 consistent with the present disclosure.

FIG. 3 is an illustrative usage example of the system of FIG. 1, consistent with the present disclosure.

FIG. 4 is an example sequence diagram for calculating range on the system of FIG. 1 consistent with the present disclosure.

FIG. 5 is an example of two of the operating modes of the system of FIG. 1 consistent with the present disclosure.

FIG. 6 is a functional block diagram illustrating one example of the system of FIG. 1 in an autonomy system, consistent with the present disclosure.

FIG. 7 is a block diagram illustrating one example of the functional allocation of hardware in the system of FIG. 1, consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present disclosure, like reference characters may indicate like structure throughout the several views, and such structure need not be separately discussed. Furthermore, any particular feature(s) of a particular exemplary embodiment may be equally applied to any other exemplary embodiment(s) of this disclosure as suitable. In other words, features between the various exemplary embodiments described herein are interchangeable, and not exclusive.

Current teaming systems between an operator and a robotic vehicle require a human operator to manually control the robot via a hand remote. This effectively eliminates the operator's situational awareness and prevents other hand-based tasks. In addition, current detection and tracking technologies cannot reliably and safely enable close quarter human-robot teaming in non-optimal environments. These non-optimal environments may include, but are not limited to, tactical environments and industrial environments.

Tactical environments may include sensor non-line-of-sight, such as GNSS denied/degraded, e.g., tunnels, buildings, dense forest, and signal jamming, smoke obscuration, snow, rain, fog, and tall grass and bushes; purposeful detection evasion, such as camouflage, radio signature restrictions, and low light or no light; and industrial environments, such as factories and mining. There exists a need for a system that allows for reliable and safe close quarter human-robot teaming in non-optimal environments, without requiring manual control or loss of situational awareness.

The present disclosure is directed to a sensor system that allows for a node, e.g., a robotic vehicle, to track another node, e.g., a dismounted soldier, by creating a wireless, hands-free connection between the nodes.

The sensor system uses two-way ranging technology that allows it to operate with safety-critical performance in environments where traditional positioning systems fail. A node according to the teachings herein uses impulse radios to implement time of flight ranging between itself and the other nodes with decimeter level accuracy. This range measurement is robust to non-optimal environments, which may include, but are not limited to, tactical environments, such as sensor non-line-of-sight, GNSS denied/degraded, tunnels, buildings, dense forest, jammed, smoke obscuration, snow, rain, fog, tall grass, and bushes; purposeful detection evasion such as camouflage, radio signature restrictions, and low or no light; and industrial environments, such as factories and mining.

The node, according to the teachings herein use an associated antenna array to obtain full two-dimensional (2D) relative positioning of the other nodes allowing for complex formation control and command behavior. The radio signature of the antenna array is configured to slip below the noise floor, for example, beyond an approximately 50-meter radius, enhancing the tactical mobility capabilities on the frontline. These characteristics make the node more performant/robust/safe in tactical environments than existing sensor systems, including physical tethers, GNSS, sonar, radar, lidar, and camera-based systems.

In the discussions that follow, an example system of a robotic vehicle as a first node and a dismounted soldier as a second node will be used for clarity. It should be noted, however, that the nodes are not limited to a robotic vehicle and a dismounted soldier, as would be known to own skilled in the art. An additional embodiment will also be discussed using the system to track personnel without a connection to a robotic vehicle, such as a firefighter in a burning building.

In an embodiment, the teachings of the present disclosure remove the need for a dedicated operator for dismount robotic operations allowing for robotic deployment to be a true capability addition to existing formations. This embodiment describes a novel combination of methods/technologies to create a highly accurate, relative positioning solution that may be specifically tailored for human-robot swarming or platooning behavior. This enables humans and mobile robots to operate within close proximity to each other for behaviors like leader/follower. For example, a mobile robot carrying supplies could use this invention to follow a soldier down a forest road and through a tunnel while maintaining close formation and a high degree of safety.

In an embodiment, the disclosed system may achieve this performance by using the following methods and hardware, which may include ultra-wide band impulse radios, for example, radios in compliance with IEEE 802.15 (internationally compatible) physical and medium access standards; two-way ranging algorithms and PHY/MAC parameters optimized for range accuracy and latency; antenna arrays designed to enable phase difference of arrival calculations in up to three dimensions and up to a 360 degree field of view.

In some embodiments, the system has a notional architecture that may include a leader module and a follower module. The leader module may include, but is not limited to, a single antenna, battery operated UWB transceiver, control interface to enable/disable following, and sensors to facilitate safety diagnostics (e.g., determine if the module is still attached to the leader). The follower module may include, but is not limited to, a multi-antenna UWB transceiver, a data processing unit to filter sensor data (e.g., Kalman filtering) and provide robust state estimates, a data interface (e.g., RJ45 TCP/IP) and API to access leader position data, and position data that may include current position, past positions, timestamps, data integrity metrics, etc.

In an embodiment, the system may include one or more operational modes, which define a position-based relationship between the leader and follower using physical analogues. These modes may include, but are not limited to, an on/off mode, a start/stop mode, a leash mode, a towbar mode, a repel mode, a shield mode, an adjust distance/offset mode, a rescue beacon mode, and a waypoint mode.

In the on/off mode, the system is turned on or off, typically be a user. In the start/stop mode, tracking is initiated or terminated, again typically by a user.

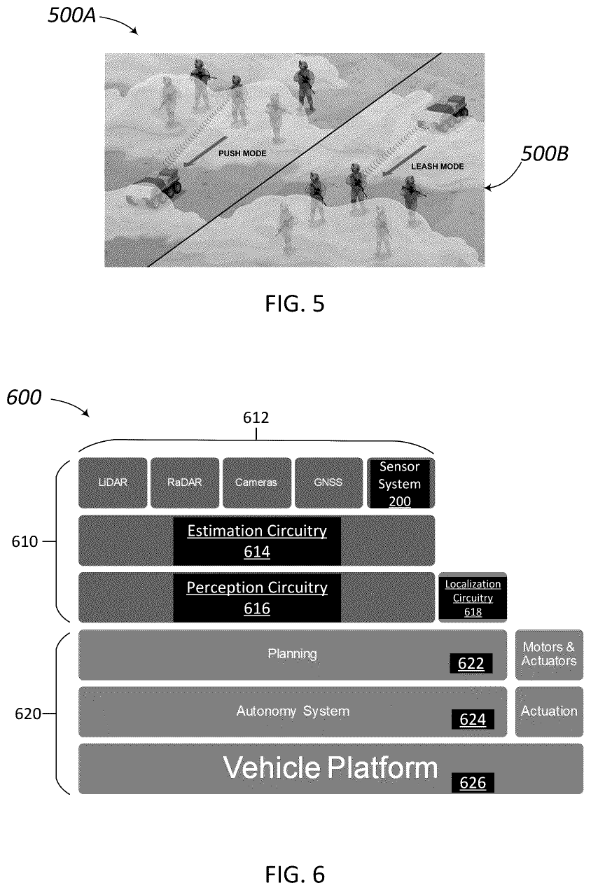

In the leash mode, the system imitates the characteristics of a leash, i.e., the leash mode includes only pull, and not push. A leash is physically defined by both its length and elasticity/stiffness. The follower is pulled in the direction of the leash via tension on the leash. A leash does not resist compression. In the leash mode the follower, e.g., a robot, is pulled behind the leader. This allows, for example, the leader to quickly grab equipment and supplies from the follower vehicle. The follower will maintain a maximum distance and allow the leader to approach without retreating. In an equipment transport scenario this allows the leader to quickly grab equipment/supplies from the follower platform. An example of the leash mode 500B is shown in FIG. 5.

In the towbar mode, the system imitates the characteristics of a rigid towbar or trailer. This mode includes both push and pull. A towbar is physically defined by its length and is expected to be infinitely stiff. The follower is both pushed and pulled which causes the follower to always mirror the movements of the leader. In the towbar mode, the follower will maintain a set distance and the leader is able to control the follower's position with great precision. In an equipment transport scenario this allows the leader to position the follower platform for unloading/storage. If the leader is also a robot, this mode enables low-speed, convoy-like operation without the use of GNSS.

In the repel mode, the system imitates the characteristics of a repelling magnet, i.e., no pull, only push. A repelling force is characterized by the field size and strength. The force is expected to grow stronger as distance is reduced. The follower will maintain a minimum distance from the leader, such that it can be pushed away. In a swarm scenario, this would allow a leader to walk through the swarm with a path automatically created wherever the leader walks. An example of the repel mode 500A is shown in FIG. 5.

In the shield mode, the system allows a leader to take cover to the side of vehicle during movement. In this mode, the vehicle will maintain a relative position with respect to the leader to provide a continuous shield as the leader moves.

In the adjust distance/offset mode, the tracking distance or offset may be adjusted. This is typically adjusted by a user.

In the waypoint mode, the follower observes the path of the leader and attempts to follow that path exactly. A path is a filtered time series of measurements of the leader's relative position. If the follower is moving (relative to the static ground plane) while observing the leader then the motion of the follower must be observed to provide a coordinate transform that normalizes/removes the follower motion from the leader's observed path.

In addition to the operational modes, the system may include one or more ancillary functions. These ancillary functions may adjust characteristics of the operation modes during runtime/operation. One example of an ancillary function may include an “adjust distance/offset” function, but many other ancillary functions may be included, as would be known to one skilled in the art.

In an embodiment, the system may have ranging relationships that may include, but are not limited to, leader-follower, where nodes are paired together, multi-leader, where multiple leader modules are paired with a single follower module, robot-robot, where follower modules share precision ranging data (often to supplement autonomy systems), multi-follower, where multiple follower modules are paired with one or more leader modules, and swarm, where all entities share range information with each other.

In an embodiment, the multi-leader mode allows a leader to hand off the follower to another leader, typically using a wireless connection. This can be a manual system, where a leader hands off the follower to another leader, or another leader can take the follower from the current leader. In another mode, the multi-leader mode may be an objective function to determine which leader to follow, based on the objective of the mission. In yet another mode, choosing the leader may be rules based, where the follower has a set of rules to determine which leader to follow. In this mode, for example, the rules may state to maintain a relative position between the leaders, such as a mid-point between the leaders.

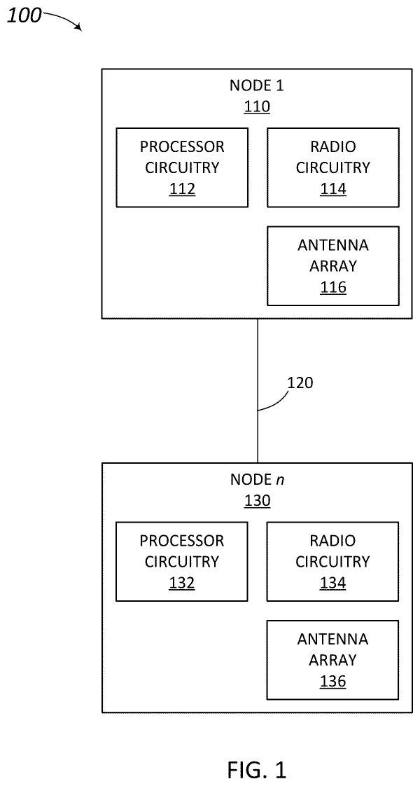

FIG. 1 is an example functional block diagram of a sensor system to track personnel, consistent with the present disclosure. The example system of FIG. 1 includes node-1 110, which may be, for example, a leader module, and node-n 130, which may be, for example, a follower module, such as a robotic vehicle. While only two nodes are shown in the example of FIG. 1, it should be noted that any number of nodes may be implemented, as would be known to one skilled in the art. The example of FIG. 1 also includes connection 120 to couple each of the nodes. In an embodiment, connection 120 may be a wireless connection, such as a UWB wireless connection. In and embodiment, the UWB radios may operate between 3.5-10 GHz, for example, at 6.5 GHz or 8 GHz where Wi-Fi and/or cellular interference is less common.

In an embodiment, node-1 110 includes processor circuitry 112, radio circuitry 114, and antenna 116. Processor circuitry 112 may be, for example, a microcontroller or other computing device, and may include non-transitory storage media to store instructions to perform the range and bearing calculations. Radio circuitry 114 may be a UWB radio, and antenna 116 may be one or more antenna to allow node-1 110 to couple with the other nodes in the system.

In an embodiment, node-n 130 includes processor circuitry 132, radio circuitry 134, and antenna 136. Processor circuitry 132 may be, for example, a microcontroller or other computing device, and may include non-transitory storage media to store instructions to perform the range and bearing calculations. Radio circuitry 134 may be a UWB radio, and antenna 136 may be one or more antenna to allow node-n 130 to couple with the other nodes in the system.

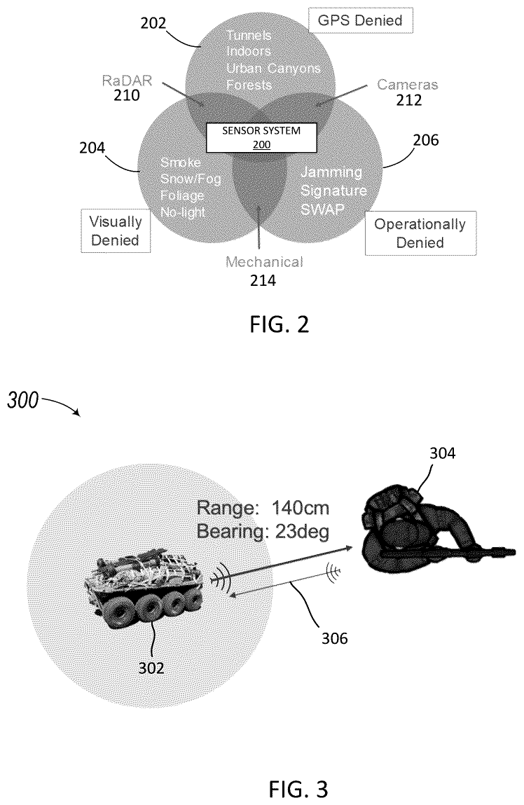

Human-robot teaming and swarm robotics require reliable localization, detection, and tracking. Existing sensor technologies do not meet performance requirements in tactical environments that include loss of GNSS, smoke/snow/visual obscurants, and detection avoidance. FIG. 2 is a chart showing the reliability of the system of FIG. 1. In the chart of FIG. 2, sensor system 200 can maintain reliable localization, detection, and tracking in GPS denied conditions 202 such as tunnels, indoors, urban canyons and forests; visually denied conditions 204 such as smoke, snow, fog, foliage, and low-or no-light; and operationally denied conditions 206 such as jamming signature and where size, weight, and power (SWaP) restraints are present. Existing technologies, including radar 210, cameras 212, and mechanical means 214 can provide reliable localization, detection, and tracking in some, but not all, of these conditions.

FIG. 3 is an illustrative usage example of the system of FIG. 1, illustrating tracking the range and bearing 306. In an embodiment, this is a relative bearing, i.e., the first node measures the relative bearing of the second node based on the first node's current direction/orientation. In the example of FIG. 3, a first node 302, for example, a robotic vehicle configured as a follower, is tracking a second node 304, for example, a dismounted soldier. Using the disclosed system, the first node 302 has calculated a range of 140 cm and a bearing of 23 degrees to the second node 304. The calculation of the range and bearing 306 are further disclosed below. The first node 302 may calculate a direction for the first node to follow based on the range and bearing 306 to the second node 304.

Time of Flight (ToF) ranging measures the distance between two devices by measuring how long it takes an electromagnetic wave to propagate from one device to another. The propagation speed of an electromagnetic wave in a vacuum or a given medium (like air) is constant and known, thus if a device can determine the propagation time, then the distance can be calculated. There are multiple approaches and methods to determine the propagation time, however they can all be broadly grouped into two categories, one-way ranging, and two-way ranging.

One-way ranging (OWR) uses communication towers (or orbiting satellites) with known absolute locations to provide absolute positioning of moving entities. Common examples include global navigation satellite systems (GNSS), positioning via cellular towers, and many real-time locations systems (RTLS) designed for indoor/warehouse use. Under one-way ranging, a signal is only sent in one direction, from device A to device B. It is important to note that in general, OWR requires time-synchronized infrastructure with known locations. In the case of cellular towers, their location is known because they are permanently deployed at a surveyed location and time synchronized via a centralized cable network. In the case of GNSS, the orbital mechanics of the satellites are well understood so the position of the satellite at the current or future time can be calculated.

One-way ranging techniques are often decomposed into downlink and uplink categories. The most common downlink system is GNSS, where orbiting satellites send time synchronized signals to the earth's surface that enable people and vehicles to calculate their global position using the signals from the satellites. An uplink system allows a central processor to calculate the position of moving entities. An example of an uplink system is an RTLS where “tags” emit a signal that is received by multiple time synchronized “anchors” which enables a central processor to calculate the position of the emitting tag.

OWR uplink systems make use of a category of methods known as multilateration. Multilateration, also known as hyperbolic positioning, is the process of locating an object by accurately computing the time difference of arrival (TDOA) of a signal emitted from the object to three or more receivers. For context, trilateration is the simpler case where only three or less receivers exist. Triangulation uses angles, not distances, to determine position.

Two-way ranging (TWR) is bidirectional. At minimum this means a signal is propagated from Entity A to Entity B and back to Entity A. In this case Entity A is referred to as the “Initiator” and Entity B the “Responder.” Unlike one-way ranging, two-way ranging does not require infrastructure or time synchronization, however, in systems with no infrastructure, two-way ranging only provides a one-dimensional range measurement rather than a 2D or three-dimensional (3D) position.

Two-way ranging can be further decomposed into solitary and collaborative method categories. Solitary two-way ranging has been widely deployed for decades in applications that are often described as “sensing.” Solitary methods often rely on the transmitted signal to passively reflect from the responder entity that is being ranged to. This often leads to high levels of environmental noise and sophisticated signal processing techniques must be employed to filter out the noise. Solitary ranging can fail for many reasons including the signal not reaching the responder, the signal not reflecting from the responder, the signal becoming lost in environmental noise, and signal processing techniques failing to filter and identify the return signal. Solitary methods could also be described as uncooperative.

Collaborative two-way ranging, on the other hand, describes the methods where the responding entity actively transmits a response or return signal. At minimum, the initiator transmits a signal, the responder receives the signal and then transmits a signal of its own, and finally the initiator receives the signal from the responder.

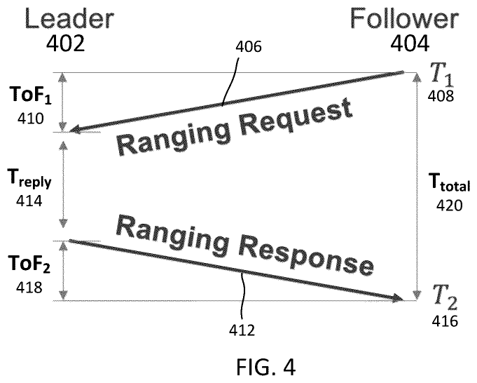

Therefore, collaborative two-way ranging is defined by an exchange of signals (e.g., messages/frames/packets). FIG. 4 shows an example of a ranging exchange often called Single Sided Two-Way Ranging (SS-TWR). Additional ranging exchanges have been devised to address performance limitations that are beyond the scope of this disclosure.

In the example of FIG. 4, follower 404 sends a ranging request 406 to leader 402 at time T₁ 408. The ranging request 406 includes the time T₁ 408. The ranging request 406 arrives at leader 402 after a ToF₁ 410. The leader may calculate the ToF₁ 410 based on the time T₁ 408. The leader 402 responds with a ranging response 412 to the follower 404 after a time T_{reply} 414. The ranging response 412 arrives at follower 404 at a time T₂ 416 after a ToF₁ 410. The leader 402 may calculate the ToF₁ 410 based on the time T₁ 408. The follower 404 may calculate the ToF₂ 418 based on the time T₂ 416. The total time for the ranging request/response is time Tₜₒₜₐₗ 420.

Separate from but related to time-of-flight ranging are methods related to measuring the direction from which a signal is received, known as Angle of Arrival (AoA). Combining ToF range and AoA results in a relative 2D or 3D position mechanistically measured in polar coordinates, but translatable into any other relative coordinate system. AoA may be used for bearing only, may be used along with ToF to determine both bearing and range, or may be used for both bearing and range when used with three or more nodes.

For a system of only two entities, direction finding generally relies on antenna characteristics of the receiver. In an embodiment, to achieve direction finding, the system may use pseudo-doppler (rotating antenna), Watson Watt (power of arrival via directional antennas), and correlative interferometry (phase difference of arrival). In other embodiments, the system may use any appropriate direction finding algorithm, as would be know to one skilled in the art.

FIG. 6 is an example functional block diagram 600 of the system from FIG. 1 in an autonomous vehicle system. The block diagram 600 includes the disclosed sensor system 610 and the autonomous vehicle system 620. The sensor system 610 includes input sensors 612 which may include, but are not limited to, lidar, radar, cameras, and GNSS. The inputs from the sensors 612 are received by the estimation circuitry 614, which filters the raw, noisy measurements from the sensors 612 to produce filtered measurements. In an embodiment, a filtering algorithm such as Kalman filtering may be used by the estimation circuitry 614.

The filtered measurements from the estimation circuitry 614 are then used in the further processes. The perception circuitry 616 develops a model of the environment from the filtered data. The localization circuitry 618 provides the localization data to the system.

In an embodiment, perception may be both mapping and fusion. Mapping may combine the filtered estimate from one sensor and placing that into a “world model” with other known object or land features. Fusion may combine the filtered estimate of one sensor with the filtered estimate of another sensor, e.g., combining the two way ranging measurement with object detection measurements from a camera system.

The filtered data and the model of environment are used by the autonomous vehicle system 620, where the planning 622 combines the model of the environment from the sensor system 610 and the objective set by the user to plan the route to meet the objective. The planning 622 interfaces with the autonomy system 624, which is the autonomy system for the actual vehicle platform 626.

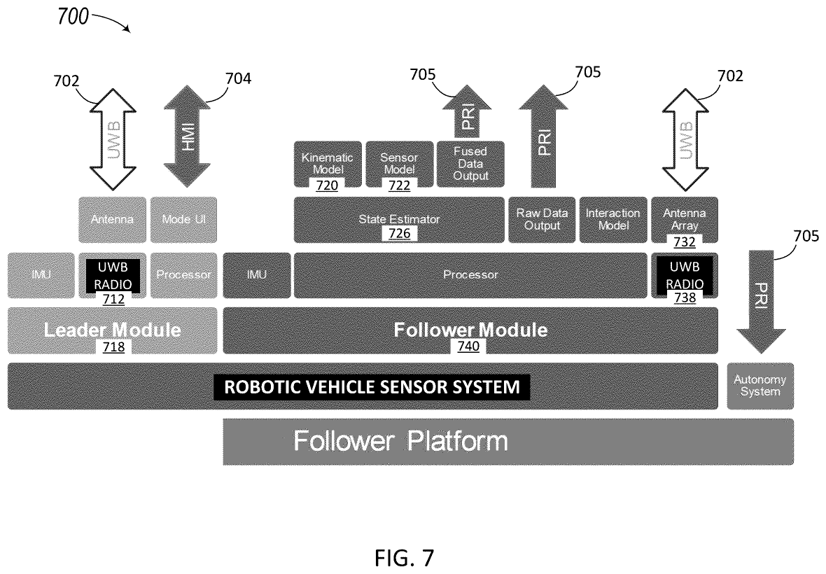

FIG. 7 is a block diagram illustrating one example of the functional allocation of hardware in the system of FIG. 1, generally designated system 700. The block diagram shows the hardware and functional allocation for one illustrative embodiment of the system 700. This is a simplified example where there is only one leader and one follower where system 700 is implemented into the autonomy systems of the follower.

The block diagram of FIG. 7 includes simplified data flow arrows. The simplified data flows include UWB 702, wireless signals sent via ultrawide band radios which provides both low data rate communication and positioning. HMI 704 is a human-machine interface, which enables a human to control and observe the system. In an embodiment, HMI 704 may be a physical button on a controller or a generic TCP/IP internet interface. PRI 705 may be sensor measurements and estimations of the leader module that include both position and uncertainty.

The leader module 718 and follower module 740 are similar in construction and only have two main differences. The leader module 718 may have a control interface that allows the leader to select an operational mode or adjust other key parameters such as following distance. The follower module 740 may contain an antenna array module 732 that enables direction finding capability, which supplements the range finding capability inherent with one antenna.

UWB radio 712 may be any compatible UWB radio, and UWB radio 738 may be an example of an UWB module that supports an antenna array and phase difference of arrival.

The state estimator 726 may be a Bayesian filter (e.g., Kalman or particle) that takes noisy raw sensor measurements and uses mathematical models to estimate the true state/position of the leader. The kinematic model 720 may be a mathematical model for the dynamics/kinematics of the leader. The sensor model 722 may be a mathematical model for the sensor characteristics (noise and biases).

In an embodiment, the disclosed system may be a body worn sensor system that provides reliable location services in adverse environments such as building collapses, fires, and/or tunnels. The system uses the two-way ranging technology described above that allows it to operate with safety-critical performance in environments where traditional positioning systems fail. The system provides location services for personnel who operate in dangerously dynamic environments (emergency responders, military personnel, etc.) whose positions need to be tracked for response management and/or potential rescue.

The disclosed system uses UWB impulse radios to achieve submeter relative positioning at a range of, for example, 500-1000 meters. This system can be deployed as an infrastructure-less positioning solution in emergency and disaster scenarios when GNSS may not be available or reliable. The system achieves relative positioning using a combination of two way ranging and an antenna array capable of calculating angle of arrival. In some embodiments, communication range can be extended with the use of an external amplifier to increase transmit power. This increase in transmit power is local regulations in the deployment area. In addition to extending range, the increase in transmit power also allows the ranging signal to penetrate buildings, walls, and other obstructions.

This system notionally consists of a beacon module, which is carried by personnel who need to be tracked, and a finder module, which includes an antenna array and processors for relative positioning calculations.

In an embodiment, a finder module could be attached to deployable assets such as a drone to extend the operational range of the system. In an embodiment, the drone would include a relay module consisting of a narrowband radio that relays location information back to a central monitor. In another embodiment, a finder module could be handheld by an operator to interactively find a beacon module. In yet another embodiment, two finder modules could be used to track each other's relative position, such as firefighters monitoring the location of their teammates in a smoke-filled room.

According to one aspect of the disclosure there is thus provided a system to track personnel, the system including: an antenna array associated with a first node to communicate with a second node; and processor circuitry. The processor circuitry to: determine a plurality of positions of the second node; determine a distance between the first node and the second node; determine a bearing between the first node and at least one of the positions; and determine a direction for the first node based on the bearing.

According to another aspect of the disclosure, there is provided a system to track personnel, the system including: an antenna array associated with a first node to communicate with a second node; and processor circuitry. The processor circuitry to: determine a distance between the first node and the second node; and maintain a position relative to the second node based on an operational mode.

According to yet another aspect of the disclosure, there is provided a system to locate personnel, the system including: a beacon module to be carried by a person; and a finder module in communication with the beacon module, the finder module configured to locate and track the beacon module.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future processor circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

What is claimed is:

1. A system to track personnel, the system comprising:
an antenna array associated with a first node to communicate with a second node; and
processor circuitry to:
determine a plurality of positions of the second node;
determine a distance between the first node and the second node;
determine a bearing between the first node and at least one of the positions; and
determine a direction for the first node to follow based on the bearing.

2. The system of claim 1, wherein the distance between the first node and the second node is determined using Time of Flight (ToF) ranging.

3. The system of claim 2, wherein the processor circuitry further configured to:
sending a ranging request to the second node;
receiving a ranging response from the second node, the ranging response including a timestamp indicating a time that the ranging response was sent by the second node;
determining a time of flight of the ranging response from the second node based on a difference between the timestamp and a received time at the first node; and
determining the distance based on the time of flight.

4. The system of claim 1, wherein the first node is configured to communicate with the second node using an ultra-wide band (UWB) impulse radio.

5. The system of claim 1, wherein a Bayesian filter uses mathematical models to estimate a true state/position of the second node.

6. The system of claim 1, wherein the system includes a human-machine interface (HMI) to enables a human to control and observe the system.

7. The system of claim 1, wherein the first node and the second node are each configured to operate in a leash mode in which the first node to maintain a maximum distance from the second node, and the first node moves in a direction of the second node.

8. The system of claim 1, wherein the first node and the second node are each configured to operate in a towbar mode in which the first node maintains a selected distance from the second node.

9. The system of claim 1, wherein the first node and the second node are each configured to operate in a repel mode in which the first node maintains a minimum distance from the second node as the second node moves.

10. The system of claim 1, wherein the first node and the second node are each configured to operate in a shield mode in which the first node maintains a relative position with respect to the second node as the second node moves to provide a continuous shield as the second node moves.

11. A system to track personnel, the system comprising:
an antenna array associated with a first node to communicate with a second node; and
processor circuitry to:
determine a distance between the first node and the second node; and
maintain a position relative to the second node based on an operational mode.

12. The system of claim 11, wherein the operational mode include at least one of an on/off mode, a start/stop mode, a leash mode, a towbar mode, a repel mode, a shield mode, an adjust distance/offset mode, a rescue beacon mode, and a waypoint mode.

13. The system of claim 11, wherein determine the distance between the first node and the second node further comprises:
sending a ranging request to the second node;
receiving a ranging response from the second node, the ranging response including a timestamp indicating a time that the ranging response was sent by the second node;
determining a time of flight of the ranging response from the second node based on a difference between the timestamp and a received time at the first node; and
determining the distance based on the time of flight.

14. The system of claim 11, wherein a bearing to the second node is determined by at least one of a rotating antenna, a power of arrival via directional antennas, and a phase difference of arrival of a signal generated by the second node and received by the first node.

15. The system of claim 11, wherein the first node is configured to communicate with the second node using an ultra-wide band (UWB) impulse radio.

16. A system to locate personnel, the system comprising:
a beacon module to be carried by a person; and
a finder module in communication with the beacon module, the finder module configured to locate and track the beacon module.

17. The system of claim 16, wherein the finder module to determine a distance to the beacon module using Time of Flight (ToF) ranging.

18. The system of claim 16, wherein the finder module includes an antenna array, wherein the antenna array is configured to communicate with the beacon module using an ultra-wide band (UWB) impulse radio.

19. The system of claim 18, the antenna array further configured to calculate an angle of arrival.

20. The system of claim 18, wherein two finder modules are each used to track a relative position of any other finder module.
